(19) United States
(12) Patent Application Publication
(10) Pub. No.: US 2026/0027863 A1
(43) Pub. Date: Jan. 29, 2026

(54) SPRING ISOLATOR AND WEAR BAND

(71) Applicant: Fox Factory, Inc., Duluth, GA (US)

(72) Inventors: Nathaniel Lundstrom, Santa Cruz, CA (US); Eliud Luna, Santa Cruz, CA (US)

(73) Assignee: Fox Factory, Inc., Duluth, GA (US)

(21) Appl. No.: 18/784,412

(22) Filed: Jul. 25, 2024

(51) Int. Cl. B60G 15/06

(52) U.S. Cl. CPC B60G 15/063; B60G 2204/1242; B60G 2204/41

(57) ABSTRACT

A dual rate spring system is disclosed. The dual rate spring system can include a spring coupler for coupling a first spring with a first spring rate to a second spring with a second spring rate, wherein said spring coupler has an annular structure disposed about a surface of a damper body and is capable of sliding axially along said surface of said damper body. The dual rate spring system can further include a spring isolator configured to be compressible and to prevent vibrations between said first spring and further include a first portion configured to be positioned between said first spring and said spring coupler and a second portion configured to be positioned between a closed coil of said first spring and a main body coil of said first spring. The dual rate spring system can also include a wear band.

### FIELD OF THE INVENTION

Embodiments of the present technology relate generally to a dual rate spring system with a spring coupler including a spring isolator and/or a wear band for noise reduction.

### BACKGROUND

Shock assemblies (e.g., dampers, shock absorbers, springs etc.) are used in numerous different vehicles and configurations to absorb some or all of a movement that is received at an unsprung portion of a vehicle before it is transmitted to a suspended portion of the vehicle. For example, when a wheel hits a pothole, the encounter will cause an impact force on the wheel. However, by utilizing suspension components including one or more shock assemblies, the impact force can be significantly reduced or even absorbed completely before it is transmitted to a person on a seat of the vehicle. Certain shock absorbers utilize a coil spring or a plurality of coil springs to affect operating characteristics of the damper.

### BRIEF DESCRIPTION OF THE DRAWINGS

Aspects of the present invention are illustrated by way of example, and not by way of limitation, in the accompanying drawings, wherein:

FIG. 1A, is a side view of dual rate spring system, shown in accordance with an embodiment.

FIG. 1B, is a cross-section view of dual rate spring system, shown in accordance with an embodiment.

FIG. 2, is a side view of a closed coil spring, shown in accordance with an embodiment.

FIG. 3, is a perspective view of a dual rate spring system, shown in accordance with an embodiment.

FIG. 4, is a cross section view of a dual rate spring system, shown in accordance with an embodiment.

FIG. 5, is a cross section view of dual rate spring system, shown in accordance with an embodiment.

FIG. 6A, is a perspective view of a portion of a dual rate spring system, shown in accordance with an embodiment.

FIG. 6B, is a perspective view of a portion of a spring isolator, shown in accordance with an embodiment.

FIG. 7, is a perspective view of a spring system with a first spring and a spring isolator, shown in accordance with an embodiment.

FIG. 8, is a cross section view of a dual rate spring system with a wear sleeve and a wear band, shown in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

### Dual Rate Spring System

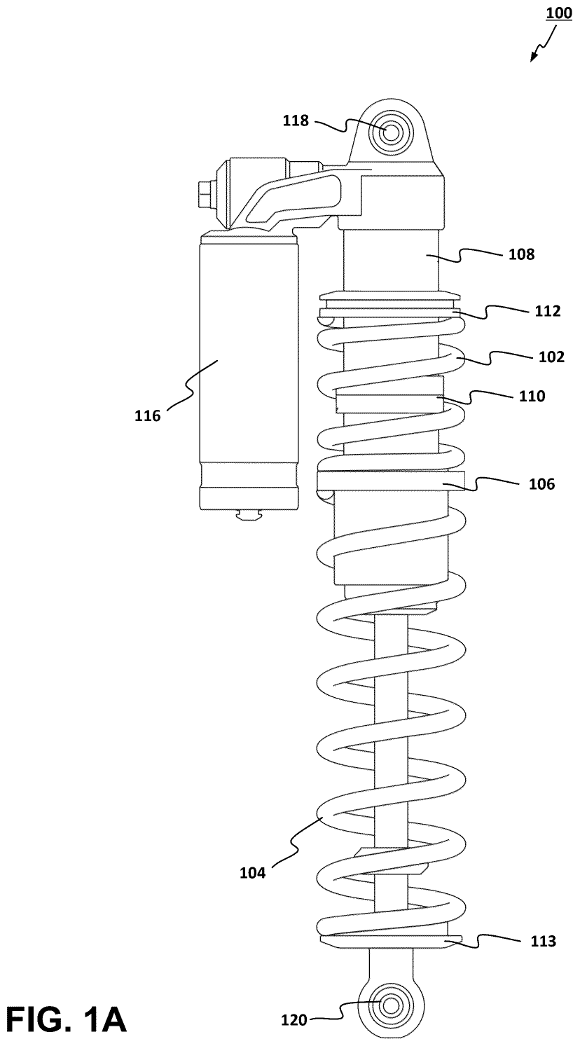

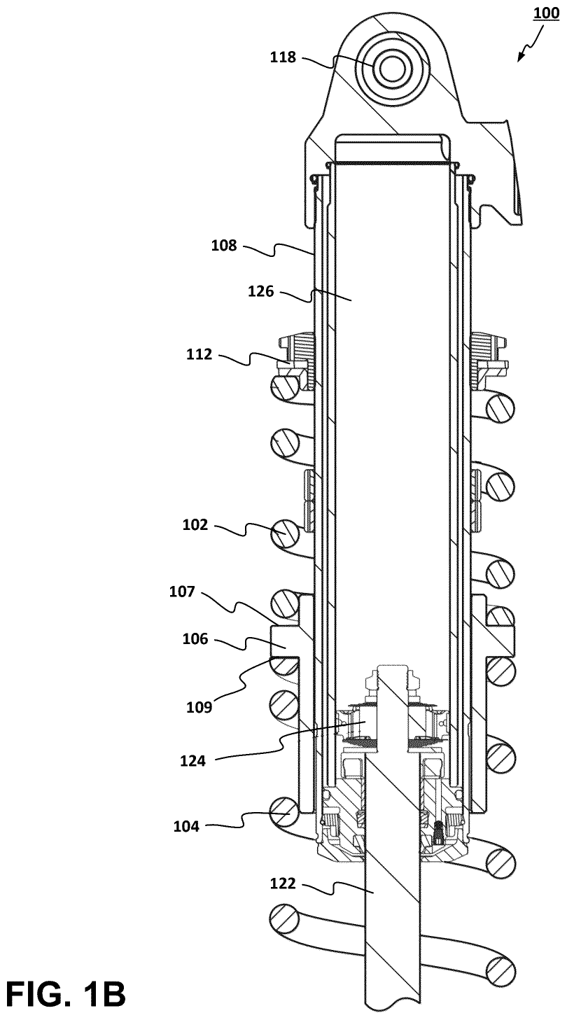

Referring now to FIG. 1A, a side view of dual rate spring system 100. Dual rate spring system 100 can be installed on a vehicle as part of a suspension system for the vehicle. Dual rate spring system 100 includes a first spring 102, a second spring 104, a spring coupler 106, a damper body 108, a crossover ring 110, a top retainer 112, and an additional reservoir 116.

Dual rate spring system 100 is depicted as having two springs. For purposes of brevity and clarity, the present Detailed Description of Embodiments and the corresponding Figures will refer to a dual rate spring system, It should be noted, however, the various embodiments of the present invention are also well-suited to use in spring systems having more than two springs. Referring again to FIGS. 1A and 1B, in one embodiment, first spring 102 is a tender spring and second spring 104 is a primary spring. It will be understood that a spring is defined as having a spring constant which is represented as “k”. The spring constant, k, generally refers to the overall stiffness of a spring. More specifically, the spring constant, k, corresponds to the amount of force required to stretch or compress the spring a given distance. Hence, the higher the spring constant, k, the greater the force required to stretch or compress the spring a given distance. For example, a tender spring may have a spring rate or k value that is lower than a spring rate or k value of the primary spring. First spring 102 can be coupled to second spring 104 via spring coupler 106. Spring coupler 106 can have first spring seat 107 which is a first surface feature for receiving an end of first spring 102 and a second spring seat 109 which is a second surface feature for receiving and end of second spring 104. For example, the first and second surface feature can have flanges and shapes designed for an end of a spring to nestle into a groove, shoulder, or spring seat of the surface feature. First spring 102, second spring 104, and spring coupler 106 can each radially surround damper body 108 as depicted. Spring coupler 106 can have an annular structure disposed about an outer surface of damper body 108 and move or slide axially up and down a surface of damper body 108 during operations of dual rate spring system 100 such as compression or rebound events.

During a compression event, second spring 104 and spring coupler 106 can move axially up damper body 108 and compress first spring 102. First spring 102 can be prevented from moving off of damper body 108 via top retainer 112. A Top retainer 112 can be coupled to or fixed relative to damper body 108. A bottom retainer 113 can be in contact with a bottom of second spring 104 and prevent second spring 104 from moving off of damper body 108. In one embodiment, second spring 104 has a greater spring rate than first spring 102 and therefore second spring 104 may not compress before first spring 102. During a compression of first spring 102, spring coupler 106 can contact crossover ring 110 and prevent or stop first spring 102 from compression further. Crossover ring 110 can have an annular structure disposed about an outer surface of damper body 108 and is fixed or coupled to damper body 108 at a point along an axial length of damper body 108 such that crossover ring 110 may not move after being contacted by spring coupler 106. A position of crossover ring 110 on a surface along an axial length of damper body 108 can be moved such that crossover ring 110 can be unfixed or uncoupled from a first position and moved to a second position along damper body 108 where crossover ring 110 is fixed or coupled to damper body 108. After spring coupler 106 has contacted crossover ring 110 during the compression event, second spring 104 can compress. Thus dual rate spring system 100 can experience two different spring force curves due to the two different spring rates of first spring 102 and second spring 104.

Additional reservoir 116 can include a chamber for additional fluid or gas. Eyelet mount 118 and eyelet mount 120 can be employed to mount dual rate spring system 100 to a vehicle. In operation, when the suspension encounters a bump, dual rate spring system 100 enters a compression stage where the distance between eyelet mount 118 and eyelet mount 120 is reduced as the length first spring 102 and/or second spring 104 is compressed. After the compression stage, dual rate spring system 100 enters a rebound stage where first spring 102 and/or second spring 104 provides a pressure on dual rate spring system 100 to return to its resting size.

In general, a dual rate spring system can have an initial lighter stiffness rate for regular operation, but will transition to a harder stiffness rate upon encounter of a compression causing event. For example, the initial stiffness of dual rate spring system 100 will be soft due to the softer spring force of first spring 102 as compared to second spring 104. As dual rate spring system 100 compresses, so will first spring 102 and second spring 104, until a point where spring coupler 106 will be stopped by crossover ring 110. In general, crossover ring 110 is located at a point before first spring 102 is fully compressed. Once spring coupler 106 meets crossover ring 110, first spring 102 is no longer part of the spring stiffness calculation and the rest of the spring compression is placed on second spring 104. At that time, the spring rate is increased to the spring stiffness of second spring 104.

In general, by adjusting a position of crossover ring 110, the length of the damper stroke at the first spring rate is defined. For example, if dual rate spring system 100 has a 12 inch stroke and the crossover point is set at 6″ of stroke, the system will use the lighter spring rate of first spring 102 for the first 6 inches of travel and then transition to the heavier spring rate of second spring 104 for any remaining compression. Thus, as different terrain is encountered, the ability to adjust the location of crossover ring 110 (and thus the length), is important to damper performance, ride quality, and possibly component or system damage.

Referring now to FIG. 1B, a cross-section view of dual rate spring system 100. During a compression event, a damping rod 122 can move axially up into a damping chamber 126 of damper body 108. Damping rod 122 is coupled with a damping piston 124 that moves telescopically into and out of damping chamber 126 in an axial direction. As damping piston 124 moves into damping chamber 126, the volume of damping chamber 126 is reduced and fluid in damping chamber 126 can be displaced. For example, the fluid can be displaced into additional reservoir 116 which is in fluid communication with damping chamber 126. Fluid communication between damping chamber 126 and additional reservoir 116 may be via a flow channel including an adjustable needle valve.

In one embodiment, additional reservoir 116 has a fluid filled portion and a gas filled portion separated by an internal floating piston. Fluid entering additional reservoir 116 can move the internal floating piston to compress gas in the gas filled portion to compensate for a reduction in volume in damping chamber 126 as damping rod 122 moves into damping chamber 126. In one embodiment, dual rate spring system 100 does not include additional reservoir 116.

In one embodiment, during the compression event, damping rod 122 and damping piston 124 move axially with second spring 104 as second spring 104 moves axially up and is compressed after spring coupler 106 contacts crossover ring 110. It should be appreciated that that damping chamber 126 including the fluid, damping piston 124, and additional reservoir 116 work together to dampen spring forces of first spring 102 and second spring 104. In its basic form, the damper works in conjunction with the helical springs and controls the speed of movement of the damping rod by metering incompressible fluid from one side of the damper piston to the other, and additionally from damping chamber 126 to additional reservoir 116, during a compression stroke (and in reverse during the rebound or extension stroke).

### Closed Coil Spring

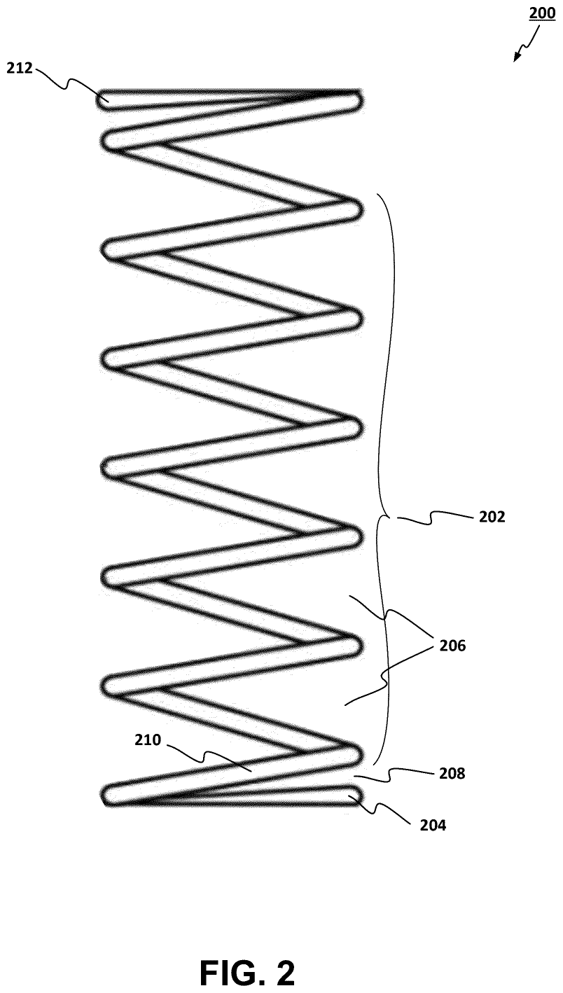

Referring now to FIG. 2, a side view of a closed coil spring 200. Closed coil spring 200 can be either first spring 102 or second spring 104 of FIGS. 1A and 1B. Closed coil spring 200 is depicted in an uncompressed state. Closed coil spring 200 includes main coils 202 and closed coil 204. Closed coil 204 is depicted has having a configuration different than main coils 202. For example, closed coil 204 can allow for an end plane of closed coil spring 200 to have an orientation that is substantially perpendicular to an axial length of closed coil spring 200. A cross section view of the coils of main coils 202 can be round in shape whereas a cross section view of closed coil 204 can change as closed coil 204 reaches a terminal end. For example, closed coil 204 can form a flat surface at the end plane of closed coil spring 200 such that a cross section of closed coil 204 can start as round and taper down to a semi-circular shape as closed coil 204 terminates. Although closed coil 204 is shown as semi-circular in shape in accordance with an embodiment, in another embodiment, closed coil 204 is another shape that is capable of forming a closed coil. This orientation can be useful for seating a first or second spring in a spring coupler such as spring coupler 106 of FIGS. 1A and 1B. A spacing 206 between coils of main coils 202 can be uniform or regular relative to one another. Spacing 208 between closed coil 204 and coil 210 of main coils 202 is not uniform and becomes increasingly smaller until closed coil 204 contacts or nearly contacts coil 210.

In one embodiment, closed coil spring 200 can have a closed coil located at each end of closed coil spring 200 such as closed coil 204 and closed coil 212. In one embodiment, closed coil 212 will have similar features and capabilities as closed coil 204. Because spacing 208 becomes increasingly smaller, closed coil 204 and coil 210 can contact one another during a compression of closed coil spring 200. In one embodiment, closed coil spring 200 is one of two closed coil springs used in series in a suspension assembly. The two closed coil springs are separated by a spring coupler/divider and friction is caused by a surface to surface interaction of the spring coupler interfacing to an inner body such as a wear sleeve or shock body. The friction causes the spring coupler to oscillate from static to dynamic states as the coupler translates with spring compression or extension. The oscillation in the spring coupler transmits to one or more of the two closed coil springs as vibration. The vibration can cause one or more of the two closed coil springs to propagate noise as well as one or more closed coils of the two closed coil springs to vibrate on an adjacent coil, causing noise. For example, closed coil spring 200 can be a spring in a dual spring shock assembly mounted in a vehicle. When the dual spring shock assembly is compressed the elackingnoise can result. The noise may be referred to as a “honking” noise. Embodiments of the present technology can reduce or eliminate such noise. The noise can be caused by a shock assembly compressing or extending.

### Spring Isolator

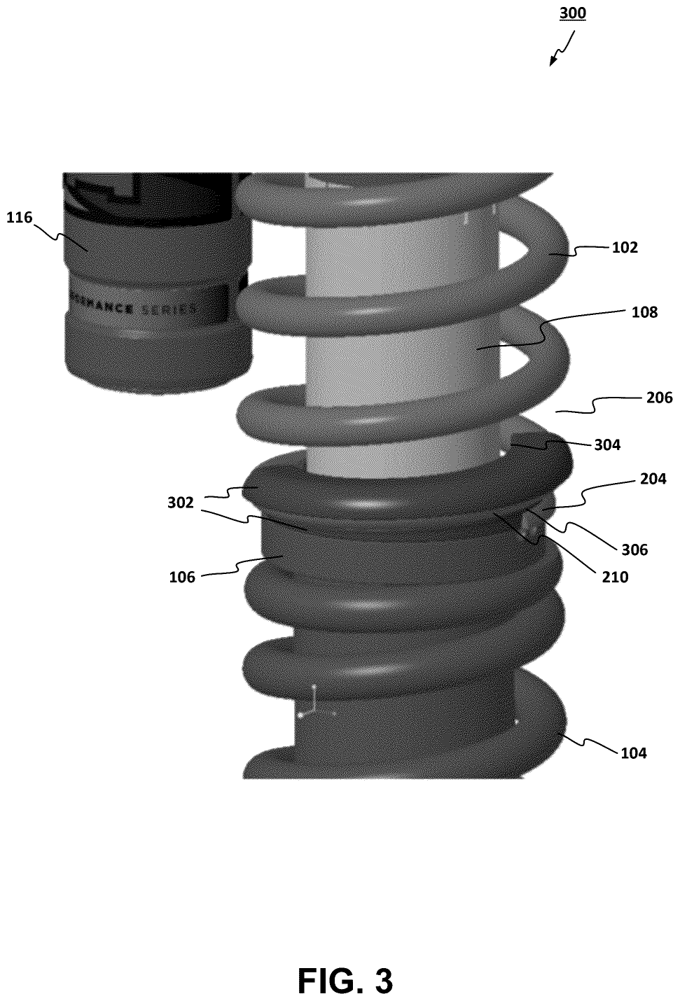

Referring now to FIG. 3, a perspective view of a dual rate spring system 300 with first spring 102, second spring 104, spring coupler 106, and a spring isolator 302. In one embodiment, dual rate spring system 300 has a number of similar features, capabilities and components as described for dual rate spring system 100. For purposes of clarity, the discussion of the features, capabilities and components of dual rate spring system 300 similar to those of dual rate spring system 100 is not repeated but is instead incorporated herein by reference.

Spring isolator 302 is depicted as a one piece component that partially surrounds a portion of closed coil 204 and partially surrounds a portion of coil 210. In one embodiment, a first portion 304 of spring isolator 302 is positioned between first spring 102 and spring coupler 106. In one embodiment, a second portion 306 of spring isolator 302 is positioned between closed coil 204 of first spring and coil 210 of first spring 102 where coil 210 is one of a plurality of main body coils of first spring 102. Spring isolator 302 can be compressible and configured to prevent or damp vibrations, contact, and noises between first spring 102 and spring coupler 106 as well contact and noises between closed coil 204 and coil 210.

It should be appreciated that spring isolator 302 can have a variety of shapes and sizes to accommodate various designs and various shape of springs. In one embodiment, damper body 108 has an outer diameter (OD) and first spring 102 has an inner diameter (ID) and the spring isolator 302 is positioned between the OD of damper body 108 and the ID of the first spring 102. In one embodiment, spring isolator 302 is a crescent shape that extends around a radial portion of spring coupler 106 and damper body 108 as is depicted in FIG. 3. For example, spring isolator 302 can extend 180 degrees around spring coupler 106. Alternatively, spring isolator 302 can extend any degree of distance around spring coupler 106 such as 30 degree, 90 degrees, 270 degrees, etc. In one embodiment, spring isolator 302 has an annular shape that extends radially encompasses (e.g. 360 degrees) a portion of spring coupler 106.

In one embodiment, spring isolator 302 is composed of an elastomer material that is compressible. It should be appreciated that that spring isolator 302 can be composed of other compressible material such as rubber. In one embodiment, spring isolator 302 has an interference fit between an ID of first spring 102 and an OD of spring coupler 106. Such an interference fit can center or assist in centering spring coupler 106 within the ID of first spring 102. In one embodiment, spring isolator 302 is formed with grooves that are semi-circular in shape that are configured to receive portions of the coils of first spring 102 such as closed coil 204 and coil 210. Although the grooves of spring isolator 302 are semi-circular in shape in accordance with an embodiment, in another embodiment, the grooves of spring isolator 302 are another shape capable of receiving coils or closed coils. An opposite surface of spring isolator 302 from the grooves can be configured to receive a surface of spring coupler 106.

In one embodiment, a dual spring system can include more than one spring isolator. For example, more than one spring isolator can be used between different portions of first spring 102 and spring coupler 106. In another embodiment, more than one spring isolator can be used between different coils of first spring 102. In another embodiment, spring isolator 302 can be included in a dual spring system and a second spring isolator can be positions between second spring 104 and spring coupler 106. A portion of the second spring isolator can also be positioned between coils of second spring 104.

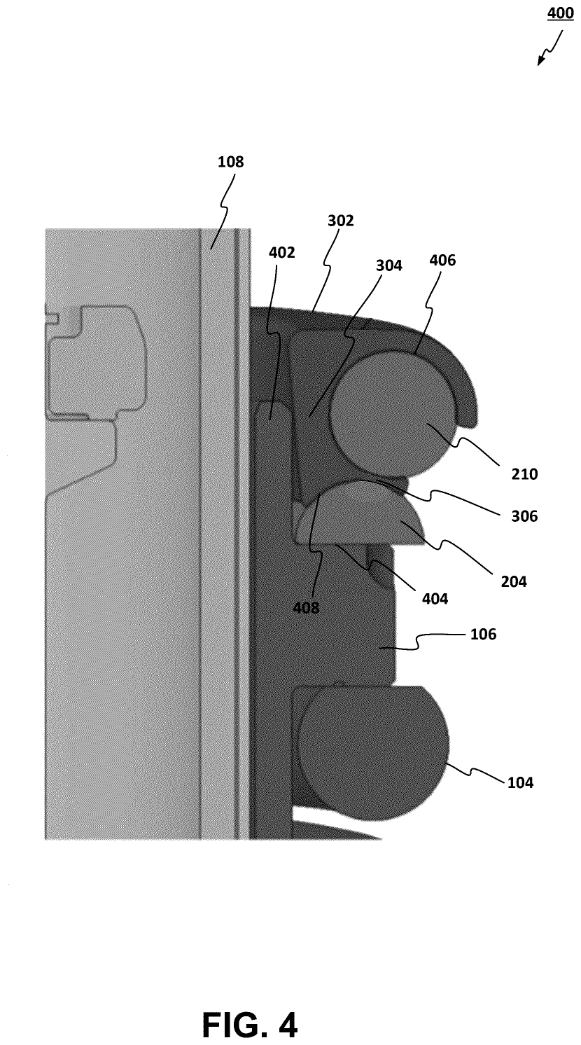

Referring now to FIG. 4, a cross section view 400 of dual rate spring system 300 of FIG. 3. In one embodiment, dual rate spring system 400 has a number of similar features, capabilities and components as described for dual rate spring system 100 or dual rate spring system 300. For purposes of clarity, the discussion of the features, capabilities and components of dual rate spring system 400 similar to those of dual rate spring system 100 and/or dual rate spring system 300 is not repeated but is instead incorporated herein by reference.

Cross section view 400 depicts first portion 304 of spring isolator 302 positioned between first spring 102 and a flange 402 of spring coupler 106 to prevent vibrations and noises between first spring 102 and spring coupler 106. Cross section view 400 also depicts second portion 306 of spring isolator 302 positioned between closed coil 204 of first spring and coil 210 of first spring 102 to prevent vibrations and noises between closed coil 204 and coil 210.

Cross section view 400 depicts a cross section of closed coil 204 that is semi-circular in shape with a flat surface 404 that contacts a surface of spring coupler 106. Cross section view 400 depicts groove 406 of spring isolator 302 that is semi-circular in shape and partially encompasses or surrounds coil 210 as well as groove 408 that is semi-circular in shape and partially encompasses or surrounds closed coil 204. Although groove 406 and groove 408 are semi-circular in shape in accordance with an embodiment, in another embodiment, one or both of groove 406 and groove 408 are another shape capable of partially encompassing or surrounding a closed coil.

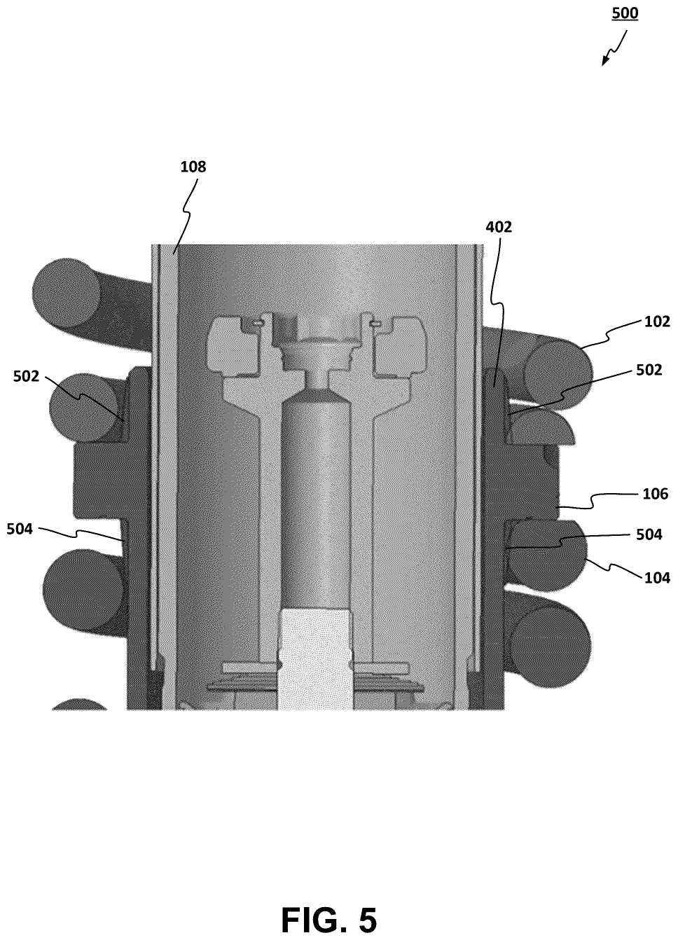

Referring now to FIG. 5, a cross section view of dual rate spring system 500. In one embodiment, dual rate spring system 500 has a number of similar features, capabilities and components as described for dual rate spring system 100, dual rate spring system 300, or dual rate spring system 400. For purposes of clarity, the discussion of the features, capabilities and components of dual rate spring system 500 similar to those of dual rate spring system 100, dual rate spring system 300, and/or dual rate spring system 400 is not repeated but is instead incorporated herein by reference.

Dual rate spring system 500 depicts an alternative embodiment with first spring isolator 502 and second spring isolator 504. First spring isolator 502 is configured to be positioned between first spring 102 and spring coupler 106. Second spring isolator 504 is configured to be positioned between second spring 104 and spring coupler 106. First spring isolator 502 and second spring isolator 504 depict embodiments with no portions of the spring isolator being positioned between a closed coil and another coil of either first spring 102 or second spring 104. In various embodiments, first spring isolator 502 and second spring isolator 504 can be configured to have portions of material between a closed coil and another coil of either first spring 102 or second spring 104. Dual rate spring system 500 depicts embodiments where first spring isolator 502 and second spring isolator 504 are annular in shape and each radially extend around spring coupler 106.

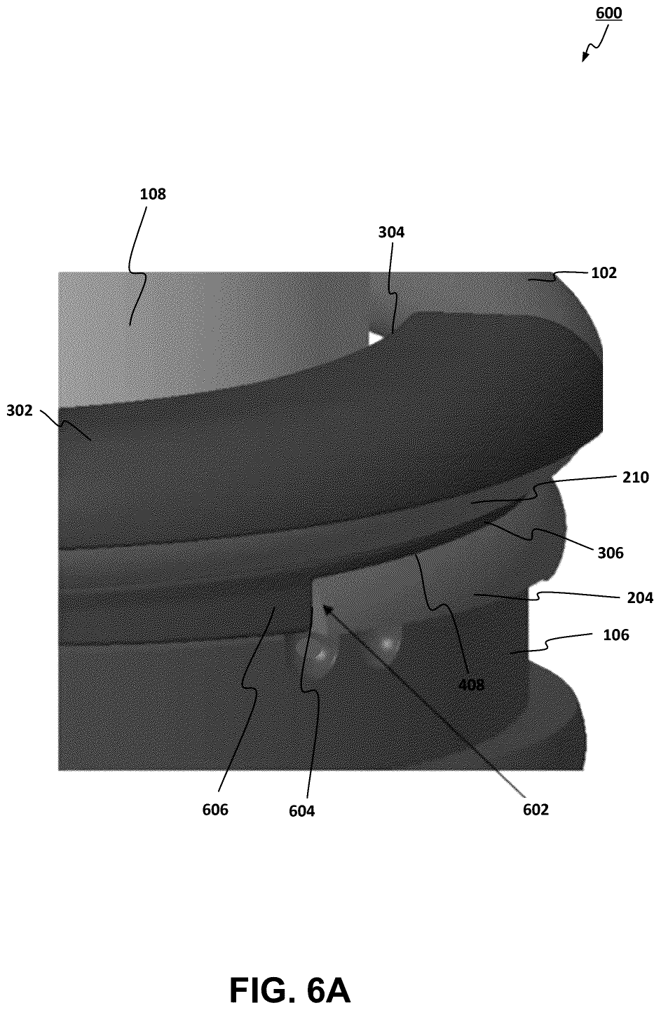

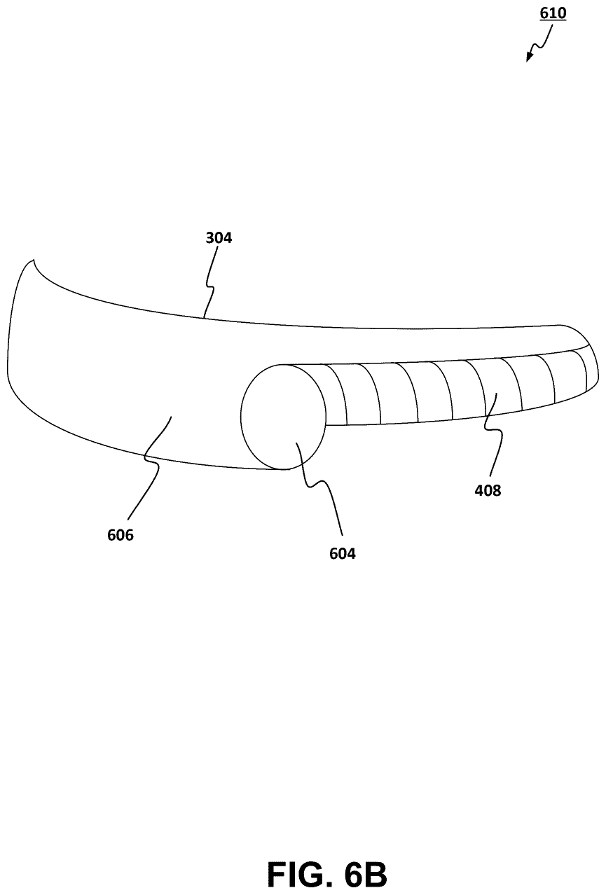

Referring now to FIG. 6A, a perspective view 600 of a portion of a dual rate spring system is shown. In one embodiment, the dual rate spring system of FIG. 6A has a number of similar features, capabilities and components as described for dual rate spring system 100, dual rate spring system 300, dual rate spring system 400, or dual rate spring system 500. For purposes of clarity, the discussion of the features, capabilities and components of the dual rate spring system of FIG. 6A that are similar to those of dual rate spring system 100, dual rate spring system 300, dual rate spring system 400, and/or dual rate spring system 500 are not repeated but are instead incorporated herein by reference.

Closed coil 204 is depicted has having an end 602 that terminates first spring 102. End 602 of closed coil 204 contacts or butts up against surface 604 of spring isolator 302. A portion of spring isolator 302 forms groove 408 that can be semi-circular in shape and configured to receive a portion of closed coil 204. A portion 606 of spring isolator 302 does not include groove 408 and is therefore thicker than the portion of spring isolator 302 that has the groove 408. The portion 606 along with surface 604 form a shoulder of spring isolator 302 that can be referred to as a spring end coil retention portion. The spring end coil retention portion of spring isolator 302 that includes surface 604 and portion 606 can be configured to secure a position of the spring isolator 302 in relation to first spring 102 such that spring isolator 302 will not move or will be prevented from moving out position during operation of the dual spring shock assembly. During installation of spring isolator 302, a tool may be used to pry apart closed coil 204 from coil 210 and thus increase the spacing 208 of FIG. 2 that is depicted as being filled with portion 306. Once spacing 208 has been increased, spring isolator 302 can be pressed into position and then rotated until surface 604 of spring isolator 302 contacts end 602 of closed coil 204. The tool can then be removed and the spacing 208 can return to normal size and be filled with portion 306.

Referring now to FIG. 6B, a perspective view 610 of a portion of spring isolator 302 of FIG. 6A. Perspective view 610 depicts a portion of spring isolator 302 without depicting first spring 102 or spring coupler 106 and clearly demonstrates surface 604 along with groove 408 of spring isolator 302. Portion 606 of spring isolator 302 can also clearly be seen to be thicker than the portion of spring isolator 302 that includes groove 408.

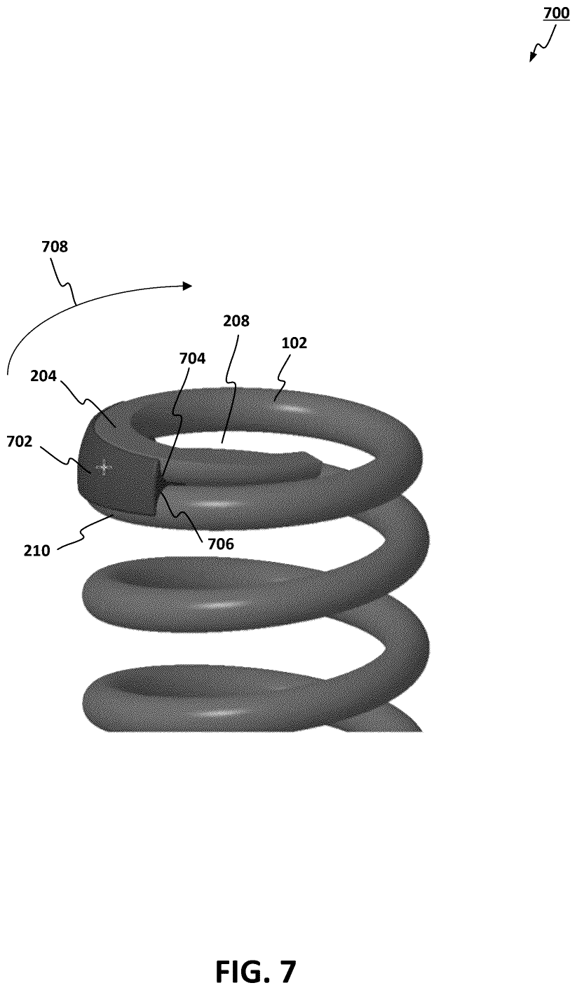

Referring now to FIG. 7, a perspective view of a spring system 700 with first spring 102 and spring isolator 702. Spring isolator 702 is depicted as a one piece component with groove 704 and groove 706. In one embodiment, groove 704 and groove 706 are each semi-circular in shape. In another embodiment, one or both of groove 704 and groove 706 are another shape capable of partially encompassing or surrounding closed coil 204 or coil 210. Groove 704 partially surrounds closed coil 204 and groove 704 can change in shape as closed coil 204 changes in shape. Groove 706 partially surrounds coil 210 of first spring 102. Spring isolator 702 fills at least a portion of spacing 208 between closed coil 204 and coil 210. It should be appreciated that spacing 208 changes in shape and spacing as closed coil 204 terminates. Spacing 208 can increase in size in the direction of arrow 708. In the opposite direction of arrow 708, spacing 208 will decrease in size until closed coil 204 contacts or nearly contacts coil 210. Such a change in size of spacing 208 can allow spring isolator 702 to shift or move during operations of a dual spring shock assembly. For example, during operations first spring 102 and spring isolator 702 can compress and thus force spring isolator 702 in the direction of arrow 708 relative to first spring 102 and in the direction where spacing 208 increases in size.

An embodiment of a spring isolator that includes a spring end coil retention portion with a shoulder such as embodiments depicted in FIGS. 6A and 6B can prevent the spring isolator from moving out of position in the direction of arrow 708. For example, surface 604 of spring isolator 302 can contact end 602 of closed coil 204 and prevent the spring isolator from moving to the increased sized spacing of spacing 208.

Embodiments of the present technology that include a spring isolator can reduce or eliminate noise and vibrations caused by a spring contacting a spring coupler or a coil of a spring contacting another coil of the same spring. Additionally, the spring isolators of the present technology can also serve to oppose spring buckling forces and prevent excessive spring buckling and thus prevent uneven wear of a spring coupler that can be cause by spring buckling. Additionally, the spring isolators of the present technology can also serve to center a spring coupler within an ID of a spring.

### Wear Sleeve

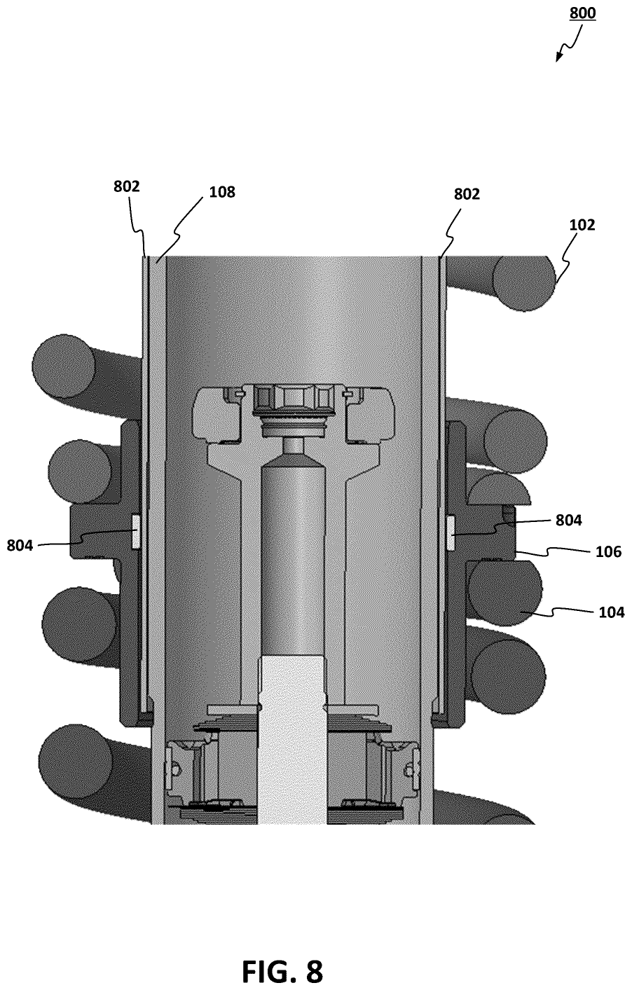

Referring now to FIG. 8, a cross section view of a dual rate spring system 800 with a wear sleeve 802. In one embodiment, dual rate spring system 800 has a number of similar features, capabilities and components as described for dual rate spring system 100, dual rate spring system 300, dual rate spring system 400, dual rate spring system 500, or the dual rate spring system of FIGS. 6A and 6B. For purposes of clarity, the discussion of the features, capabilities and components of dual rate spring system 600 similar to those of dual rate spring system 100, dual rate spring system 300, dual rate spring system 400, dual rate spring system 500, and/or dual rate spring systems of FIGS. 6A and 6B, is not repeated but is instead incorporated herein by reference.

Although the spring coupler 106 is designed to moves axially along the damper body 108, manufacturing tolerances for the first spring 102 and/or the second spring 104 can cause imperfect axial motion of the spring coupler 106. This imperfect axial motion of spring coupler 106 can cause friction between spring coupler 106 and a portion of damper body 108.

Moreover, in a muddy (gravely, sandy, or the like) environment, small particles can make their way between the spring coupler 106 and the damper body 108 to increase the friction (and thus the wear) that is occurring between the spring coupler 106 and the damper body 108. Further, any damage to the first spring 102 and/or the second spring 104 can also increase the imperfect axial motion of the spring coupler 106.

In one embodiment, the wear sleeve 802 is placed between the spring coupler 106 and the damper body 108 such that the friction (and thus the wear) from the motion of spring coupler 106 and any particles thereunder are moved from damper body 108 to wear sleeve 802.

In one embodiment, the wear sleeve 802 has an ID that is larger than an outer diameter OD of the damper body 108 such that the wear sleeve 802 will fit around the exterior portion of the damper body 108. The wear sleeve 802 also has an OD that is smaller than the ID of spring coupler 106 (and also the ID of the first spring 102, the second spring 104, etc.) such that wear sleeve 802 will fit around the exterior portion of the damper body 108 while fitting inside of the spring coupler 106 (and in one embodiment, the first spring 102, second spring 104, etc.).

In one embodiment, wear sleeve 802 will extend axially along damper body 108 at least as far as a range of motion of the spring coupler 106 that moves along damper body 108. In one embodiment, wear sleeve 802 will extend axially along the entire length of damper body 108. In one embodiment, wear sleeve 802 will extend axially along some length of damper body 108 that is less than the full length of damper body 108 and more than the range of motion of spring coupler 106.

By installing wear sleeve 802 into dual rate spring system 800 instead of having the spring coupler 106 in frictional contact with damper body 108, the spring coupler 106 will be in frictional contact with wear sleeve 802 while wear sleeve 802 is fixed in position about damper body 108. In so doing, the wear sleeve 802 provides wear resistance between the damper body 108 and any dual rate spring system components that are outside of the OD of the wear sleeve 802 (e.g., spring coupler 106, first spring 102, second spring 104), such that the previously occurring wear (or friction) on the damper body 108 will now occur on wear sleeve 802.

This previously occurring wear (or friction) will include the friction caused by any imperfect axial motion of the spring coupler 106, any damage to the first spring 102 and/or the second spring 104 that will cause additional imperfect axial motion of the spring coupler 106, small particles make their way between the spring coupler 106 and wear sleeve 802, and the like.

Thus, wear sleeve 802 will be the recipient of the friction (or wear) that would otherwise occur between the spring coupler 106, first spring 102 and/or the second spring 104 and the damper body 108.

In one embodiment, wear sleeve 802 is installed between damper body 108 and spring coupler 106 (and in one embodiment a portion of first spring 102, and or some or all of the second spring 104) and held in a fixed position with respect to damper body 108 by a retaining feature.

In one embodiment, the thickness of wear sleeve 802 is approximately 45 thousandths of an inch. In one embodiment, the wear sleeve 802 is steel. In one embodiment, the wear sleeve 802 is stainless steel. In one embodiment, wear sleeve 802 is a metal such as aluminum, titanium, copper, brass, steel, or the like. In one embodiment, wear sleeve 802 is coated with a protective coating such as a melanite coating (e.g., carbon nitriding) or the like. In one embodiment, the wear sleeve 802 is a composite material composed of polytetrafluoroethylene (PTFE) and bronze.

In one embodiment wear sleeve 802 is comprised of a composite material such as, but not limited to, glass filled nylon (such as for example, 33% glass reinforced Nylon 6/6), injection molded carbon fiber, carbon fiber with reinforced nylon, compression molding, composite layering, nylon reinforced with carbon fibers, chopped carbon fibers, a plastic, polymer, other long fiber-reinforced plastics, or the like. In one embodiment, spring coupler 106 is well suited to being formed of any material which mitigates noise generation.

In one embodiment, wear sleeve 802 could be formed from a combination of materials such as an outer harder layer such as steel and an inner composite material. In one embodiment, by forming the wear sleeve 802 from a combination of materials, the outer portion of wear sleeve 802 would have the increased wear resilience while the overall weight of wear sleeve 802 would be reduced.

### Wear Band

FIG. 8 further depicts spring coupler 106 including wear band 804 that contains a friction modifying surface. In one embodiment, wear band 804 is positioned between damper body 108 and spring coupler 106. Wear band 804 can be employed with or without wear sleeve 802. In an embodiment that includes wear sleeve 802, wear band 804 is positioned between wear sleeve 802 and spring coupler 106. In one embodiment, spring coupler 106 forms a groove around a radial surface of the ID of spring coupler 106 to contain a portion of wear band 804. Wear band 804 can then protrude from the groove in spring coupler 106 and protrude past the ID surface of spring coupler 106 such that a surface of wear band 804 will contact wear sleeve 802 or damper body 108 before or in place of the ID of spring coupler 106.

In one embodiment, wear band 804 is centrally located along an axial length of spring coupler 106. In one embodiment, wear band 804 is located at the junction between first spring 102 and second spring 104. In one embodiment, a plurality of wear band 804 can be positioned in spring coupler 106. For example, a spring coupler that is longer in an axial length can have more space for a plurality of wear bands. It should be appreciated that any number of wear bands can be used in conjunction with a spring coupler.

In one embodiment, wear band 804 is composed of a friction reducing material. For example, wear band 804 can be composed of a composite material that includes PTFE and bronze. In one embodiment, wear band 804 is a replaceable component and can be replaced with a similar or different wear band. In one embodiment, as wear band 804 moves along a surface of either damper body 108 or wear sleeve 802, wear band 804 can leave behind deposits of particles of the material of which wear band 804 is composed of. These particles can assist in reducing the friction of the surface where the particles are deposited.

In one embodiment, wear band 804 is formed using molding techniques such as injection molding. In one embodiment, wear band 804 is co-molded with the spring coupler assembly. In one embodiment, wear band 804 and spring coupler 106 are co-molded as a two part assembly. In one embodiment, wear band 804 is a steel backed composite band with a friction modifying material that snap fits into a groove or plurality of grooves in a spring coupler.

Dual rate spring system 800 depicts wear band 804 having an annular shape disposed radially about a surface. In another embodiment, spring coupler 106 is configured to employ multiple wear bands or wear strips oriented in a linear manner along an axial length of the spring coupler 106.

### Spring Isolator and Wear Band

Various embodiments of the present technology include dual rate spring assemblies that employ two springs with difference spring rates coupled via a spring couplers. Embodiments also include spring isolators, wear bands, and wear sleeves. It should be appreciated that various embodiments can include a combination of some or all of the components described herein. For example, an embodiment can include a dual rate spring assembly with both a spring isolator and a wear band. Various embodiments can include some or all of a spring isolators, wear bands, and wear sleeves.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments could be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A dual rate spring system with a spring isolator, comprising:
a spring coupler for coupling a first spring with a first spring rate to a second spring with a second spring rate, wherein said spring coupler has an annular structure disposed about a surface of a damper body and is capable of sliding axially along said surface of said damper body; and
a spring isolator configured to be compressible and to prevent vibrations between said first spring and said spring coupler comprising:
a first portion configured to be positioned between said first spring and said spring coupler; and
a second portion configured to be positioned between a closed coil of said first spring and a main body coil of said first spring.

2. The dual rate spring system of claim 1, wherein said spring isolator further comprises:
a spring end coil retention portion with a shoulder configured to engage an end of said closed coil of said first spring.

3. The dual rate spring system of claim 1, wherein said spring isolator is composed of an elastomer material.

4. The dual rate spring system of claim 1, wherein said spring isolator is configured to have an interference fit between said first spring and said spring coupler and is configured to center a portion said spring coupler within an inner diameter of said first spring.

5. The dual rate spring system of claim 1, wherein said spring isolator has a crescent shape that extend around a radial portion of said spring coupler.

6. The dual rate spring system of claim 1, wherein said spring isolator has an annular shape that extend radially around a portion of said spring coupler.

7. The dual rate spring system of claim 1, further comprising:
a second spring isolator configured to be compressible and to prevent vibrations between said second spring and said spring coupler comprising:
a first portion configured to be positioned between said second spring and said spring coupler; and
a second portion configured to be positioned between a closed coil of said second spring and a main body coil of said second spring.

8. A dual rate spring system with a wear band, comprising:
a damper body with an outer diameter (OD) and an axial length;
a spring coupler for coupling a first spring with a first spring rate to a second spring with a second spring rate, wherein said spring coupler has an annular structure with an inner diameter (ID) disposed about said OD of said damper body and is capable of sliding axially along said OD of said damper body; and
a wear band disposed about said ID of said spring coupler and configured to isolate said ID of said spring coupler from said OD of said damper body.

9. The dual rate spring system of claim 8, wherein said wear band has an annular shape and extends radially around said damper body.

10. The dual rate spring system of claim 8, wherein said wear band is centered along an axially length of said spring coupler.

11. The dual rate spring system of claim 8, further comprising:
a plurality of wear bands disposed about said ID of said spring coupler.

12. The dual rate spring system of claim 8, wherein said wear band is composed of a friction reducing material.

13. The dual rate spring system of claim 8, wherein said wear band is composed of polytetrafluoroethylene (PTFE) and bronze.

14. The dual rate spring system of claim 8, further comprising:
a wear sleeve, comprising:
a wear sleeve ID larger than said OD of said damper body;
a wear sleeve OD smaller than said ID of said spring coupler and an ID of said wear band, such that said wear sleeve is located between said damper body and said wear band; and
a wear sleeve axial length, said wear sleeve axial length at least as long as a distance of a spring coupler range of motion.

15. A dual rate spring system with a spring isolator and a wear band, comprising:
a damper body with an outer diameter (OD) and an axial length;
a spring coupler for coupling a first spring with a first spring rate to a second spring with a second spring rate, wherein said spring coupler has an annular structure with an inner diameter (ID) disposed about said OD of said damper body and is capable of sliding axially along said OD of said damper body;
a spring isolator configured to be compressible and to prevent vibrations between said first spring and said spring coupler comprising:
a first portion configured to be positioned between said first spring and said spring coupler; and
a second portion configured to be positioned between a closed coil of said first spring and a main body coil of said first spring; and
a wear band disposed about said ID of said spring coupler and configured to isolate said ID of said spring coupler from said OD of said damper body.

16. The dual rate spring system of claim 15, wherein said spring isolator further comprises:
a spring end coil retention portion with a shoulder configured to engage an end of said closed coil of said first spring.

17. The dual rate spring system of claim 15, wherein said spring isolator is configured to have an interference fit between said first spring and said spring coupler and is configured to center a portion said spring coupler within an inner diameter of said first spring.

18. The dual rate spring system of claim 15, wherein said spring isolator has a crescent shape that extend around a radial portion of said spring coupler.

19. The dual rate spring system of claim 15, wherein said wear band is composed of polytetrafluoroethylene (PTFE) and bronze.

20. The dual rate spring system of claim 15, further comprising:
a wear sleeve, comprising:
a wear sleeve ID larger than said OD of said damper body;
a wear sleeve OD smaller than said ID of said spring coupler and an ID of said wear band, such that said wear sleeve is located between said damper body and said wear band; and
a wear sleeve axial length, said wear sleeve axial length at least as long as a distance of a spring coupler range of motion.
